(19) United States
(12) Patent Application Publication
(10) Pub. No.: US 2025/0381463 A1
(43) Pub. Date: Dec. 18, 2025

(54) ALIGNMENT STRUCTURE FOR LAUNCH MONITOR AND ELECTRONIC SYSTEM INCLUDING SAME

(71) Applicant: Vieworks Co., Ltd., Anyang-si (KR)

(72) Inventors: Ha Dae JEONG, Anyang-si (KR); Tae Jun LIM, Incheon (KR)

(21) Appl. No.: 19/234,406

(22) Filed: Jun. 11, 2025

(30) Foreign Application Priority Data
Jun. 13, 2024 (KR) 10-2024-0077233

(51) Int. Cl. A63B 69/36; A63B 24/00

(52) U.S. Cl. CPC A63B 69/36; A63B 24/0021; A63B 2024/0031

(57) ABSTRACT

According to an exemplary embodiment, an alignment structure includes a connecting body, a head stick including a first head stick extending from the connecting body and a second head stick that is provided to be able to be supported from the ground by extending in a direction of the ground while being separated from the first head stick at a first angle, and a side stick configured to enable three-point support from the ground along with the second head stick.

### CROSS-REFERENCE TO RELATED APPLICATION

This application claims priority to and the benefit of Korean Patent Application No. 10-2024-0077233, filed on Jun. 13, 2024, the disclosure of which is incorporated herein by reference in its entirety.

### BACKGROUND

### 1. Field of the Invention

The technical idea of the present disclosure relates to an alignment structure for a launch monitor and an electronic system including the same.

### 2. Discussion of Related Art

Golf is a sport that requires a precise technique to achieve the best results through the correct direction and impact of a club head. To help with this, golfers often use visual indicators to help guide their swing and the direction of the club head. For this purpose, launch monitors were developed. The launch monitors are devices that provide feedback to the golfer by tracking a path of the club head and a flight path of the ball in real time when hitting the ball.

However, existing alignment structures (for example, alignment sticks) have generally been used as tools to visually assist the path of the club head. Furthermore, the alignment stick may be used as a tool to indicate the direction the golfer is aiming for.

Since most existing alignment sticks, such as the alignment stick disclosed in Korean Patent No. 10-2248980, were placed on the floor and used, the launch monitor could not accurately recognize the directions of the alignment stick, and a tilting error problem occurred due to recognizing a one-dimensional line. In addition, for outdoor launch monitors, it was inconvenient to additionally carry an alignment stick.

### SUMMARY OF THE INVENTION

The present disclosure is directed to providing an alignment structure capable of standing up, thereby increasing user convenience. The present disclosure is also directed to increasing the accuracy of identification of an alignment structure by using a launch monitor.

According to an exemplary embodiment of the present disclosure, there is provided an alignment structure including a connecting body, a head stick including a first head stick extending from the connecting body and a second head stick that is provided to be able to be supported from the ground by extending in a direction of the ground while being separated from the first head stick at a first angle, and a side stick configured to enable three-point support from the ground along with the second head stick.

Also, the head stick may include a detection line provided on a side surface of the head stick.

Furthermore, the detection line may include a first detection line provided on an inner side surface of the first head stick and a second detection line provided on an outer side surface of the second head stick.

Furthermore, the detection line may include an adhesive sheet that emits or reflects light so that a camera is able to easily identify the detection line.

Meanwhile, the second detection line may be provided on the second head stick to be spaced a predetermined margin distance apart from the ground.

Meanwhile, the connecting body may include a first connecting body and a second connecting body structurally connected to the first connecting body and capable of rotating at a first angle, and the first head stick may extend from the first connecting body and the second head stick may extend from the second connecting body.

Also, the first connecting body may include a ball plunger, and the second connecting body may include a plurality of ball plunger holes in which the ball plunger is able to be seated.

Meanwhile, the first connecting body may include a snap fit, and the second connecting body may include a sliding guide that is in contact with the snap fit to enable rotational motion.

Meanwhile, the side stick may be provided so that the side stick extends from the head stick and is configured to be folded and unfolded, and is able to be supported from the ground along with the second head stick.

Also, the side stick may include a first side stick and a second side stick, each of which includes a binding structure at one end to maintain a folded state.

According to an exemplary embodiment of the present disclosure, there is provided an alignment structure including a connecting body including a first connecting body and a second connecting body structurally connected to the first connecting body and capable of rotating at a first angle, a head stick including a first head stick extending from the first connecting body and a second head stick extending from the second connecting body and provided to be separated from the first head stick at the first angle, and a side stick configured to enable three-point support from the ground along with the second head stick.

Also, the head stick may include a detection line provided on a side surface of the head stick.

Furthermore, the detection line may include a first detection line provided on an inner side surface of the first head stick and a second detection line provided on an outer side surface of the second head stick.

In addition, the detection line may include an adhesive sheet that emits or reflects light so that a camera is able to easily identify the detection line.

Meanwhile, the second detection line may be provided on the second head stick to be spaced a predetermined margin distance apart from the ground.

Meanwhile, the first connecting body may include a ball plunger, and the second connecting body may include a plurality of ball plunger holes in which the ball plunger is able to be seated.

Also, the first connecting body may include a snap fit, and the second connecting body may include a sliding guide that is in contact with the snap fit to enable rotational motion.

Meanwhile, the side stick may be provided so that the side stick extends from the head stick and is configured to be folded and unfolded, and is able to be supported from the ground along with the second head stick.

Also, the side stick may include a first side stick and a second side stick, each of which includes a binding structure at one end to maintain a folded state.

According to an exemplary embodiment of the present disclosure, there is provided an electronic system which includes an alignment structure including: an alignment structure that includes a connecting body, a head stick including a first head stick extending from the connecting body and a second head stick extending in a direction of the ground and provided to be supported from the ground while being separated from the first head stick at a first angle, wherein the first angle is an acute angle, and a side stick configured to enable three-point support from the ground along with the second head stick; and an electronic device that photographs the alignment structure and performs alignment operations based on the results of identifying a detection line included in the head stick.

Furthermore, the electronic device may determine a hitting direction based on a virtual line connecting an end of a first detection line provided on an inner side surface of the first head stick and an end of a second detection line provided on an outer side surface of the second head stick.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a view for describing an alignment structure according to an exemplary embodiment of the present disclosure;

FIG. 2 is a view for describing the alignment structure in a folded state according to the exemplary embodiment of the present disclosure;

FIG. 3 is a side view for describing the alignment structure according to the exemplary embodiment of the present disclosure;

FIGS. 4A to 4E are views for describing a connecting body according to the exemplary embodiment of the present disclosure;

FIGS. 5A to 5C are views for describing a binding structure according to the exemplary embodiment of the present disclosure; and

FIG. 6 is a view for describing an electronic system according to the exemplary embodiment of the present disclosure.

### DETAILED DESCRIPTION OF EXEMPLARY EMBODIMENTS

Specific structural or functional descriptions of the embodiments are disclosed for illustrative purposes only and may be modified and implemented in various forms. Therefore, the actual implemented form is not limited to the specific embodiments disclosed, and the scope of this specification includes modifications, equivalents, or alternatives included in the technical idea described in the embodiments.

Although the terms first or second may be used to describe various components, these terms should be interpreted as only distinguishing one component from another. For example, a first component may be named a second component, and similarly, the second component may also be named the first component.

Singular expressions include plural expressions unless the context clearly indicates otherwise. In this document, each of the phrases “A or B,” “at least one of A and B,” “at least one of A or B,” “A, B, or C,” “at least one of A, B, and C,” and “at least one of A, B, or C” can include any one of the items listed together with the corresponding phrase among those phrases or all possible combinations thereof. In this specification, it should be understood that terms such as “comprise” or “have” are intended to specify the presence of a described feature, number, step, operation, component, part, or combination thereof, but do not exclude in advance the possibility of the presence or addition of one or more other features, numbers, steps, operations, components, parts, or combinations thereof.

Hereinafter, embodiments are described in detail with reference to the attached drawings. When describing with reference to the attached drawings, the same components are denoted by the same reference numerals regardless of the drawing numbers, and redundant descriptions thereof are omitted.

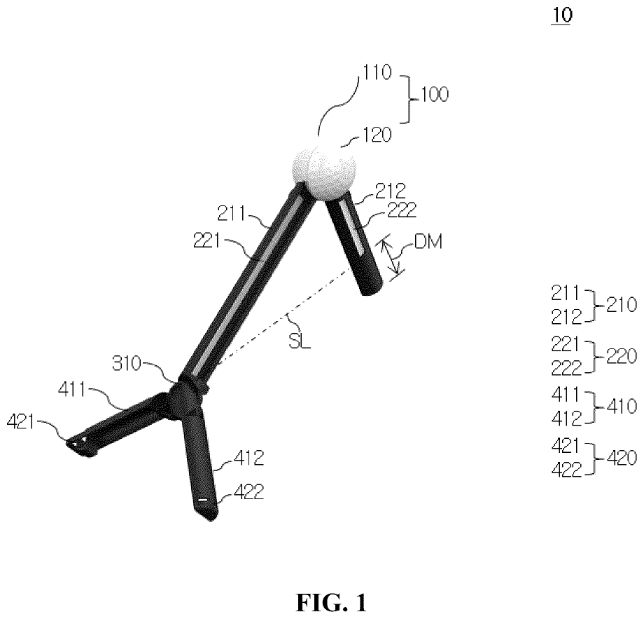

FIG. 1 is a view for describing an alignment structure according to an exemplary embodiment of the present disclosure.

Referring to FIG. 1, an alignment structure 10 may include a connecting body 100, a head stick 210, a detection line 220, a rotation center body 310, a side stick 410, and a binding structure 420.

Here, the connecting body 100 may include a first connecting body 110 and a second connecting body 120, the head stick 210 may include a first head stick 211 and a second head stick 212, the detection line 220 may include a first detection line 221 and a second detection line 222, the side stick 410 may include a first side stick 411 and a second side stick 412, and the binding structure 420 may include a first binding structure 421 and a second binding structure 422.

The alignment structure 10 according to the exemplary embodiment of the present disclosure may be set up in a region where a golfer hits a ball (for example, a ready zone) by unfolding the second head stick 212, the first side stick 411, and the second side stick 412 and having the connecting body 100 face the golfer's hitting direction. At this time, the alignment structure 10 may be set up with the detection line 220 facing a launch monitor.

The connecting body 100 may include the first connecting body 110 and the second connecting body 120 that are structurally coupled to each other, and the first connecting body 110 and the second connecting body 120 may have internal structures that enable them to rotate relative to each other. For example, the second connecting body 120 may be rotated from the first connecting body 110 at a first angle so that the alignment structure 10 may be changed from a folded state to a state in which it can be erected (ready state).

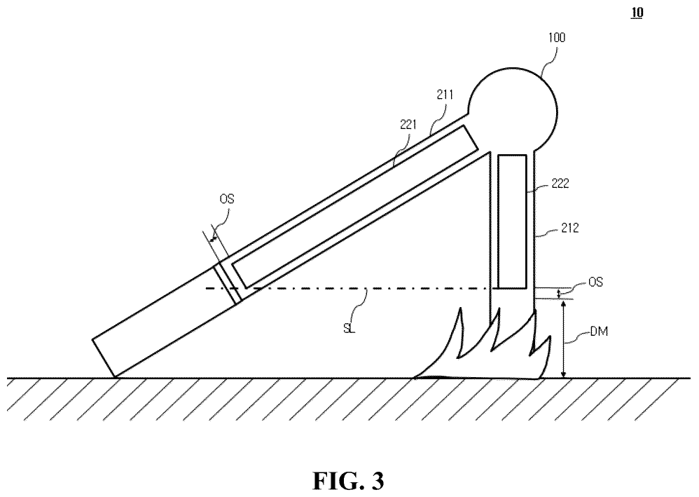

The first angle may be an acute angle. In other words, the first angle may be an angle less than 90 degrees. The first angle may include an angle between the first head stick 211 and the second head stick 212. When viewed from the side, the alignment structure 10 may be observed to have a triangular shape as shown in FIG. 3, which will be described below. The alignment structure 10 may be intended to be self-supporting on the ground based on a three-point mounting method. Accordingly, the internal structure of the connecting body 100 may be formed so that the first head stick 211 and the second head stick 212 are unfolded at an acute angle.

The first connecting body 110 and the second connecting body 120 may each have an appearance similar to a spherical shape (for example, a golf ball shape) divided in half. This can have the effect of increasing visibility for the golfer.

The first connecting body 110 and the second connecting body 120 may be provided so that the first head stick 211 and the second head stick 212 are connected to one sides thereof, respectively.

The first head stick 211 and the second head stick 212 may be formed by extending from the first connecting body 110 and the second connecting body 120, respectively.

The first head stick 211 may function as a backbone of the alignment structure 10 in a ready state to support the load of the entire structure, and the second head stick 212 may be provided to support the alignment structure 10 in the ready state from the ground. That is, the second head stick 212 may function as a leg that is supported by the ground along with the first side stick 411 and the second side stick 412.

The first head stick 211 may be relatively longer than the second head stick 212. This is to form the detection line and detection region in a triangular shape, and because the second head stick 212 is configured to support the front load of the alignment structure 10.

The detection line 220 may be provided on one side surface of the head stick 210. The detection line 220, although named as a ‘line’, may actually have a two-dimensional area recognizable by a sensing device (for example, a camera). For example, the detection line 220 may be implemented in a long rectangular shape.

The first detection line 221 may be provided on one side surface of the first head stick 211, and the second detection line 222 may be provided on the other side surface of the second head stick 212. For example, the first detection line 221 may be provided on an inner side surface of the first head stick 211, the second detection line 222 may be provided on an outer side surface of the second head stick 212, and the launch monitor may observe both the first detection line 221 and the second detection line 222 when observing one side surface of the alignment structure 10.

The detection line 220 may include an adhesive sheet that emits or reflects light so that it can be easily identified by a sensor device (for example, a camera). For example, the first detection line 221 and the second detection line 222 may be implemented in the form of stickers having a reflection coefficient of a predetermined value or more, and the launch monitor may identify the detection line 220 of the alignment structure 10.

Meanwhile, according to the embodiment, the first detection line 221 and the second detection line 222 may be provided on an outer surface of the first head stick 211 and an inner surface of the second head stick 212, respectively.

The first detection line 221 and the second detection line 222 may each include the same type of adhesive sheet, but may also each include different types of adhesive sheets. For example, adhesive sheets having different colors or different reflection coefficients may be included differently in the first detection line 221 and the second detection line 222, and the launch monitor may identify the first detection line 221 and the second detection line 222 as different detection lines.

The first detection line 221 may be provided internally at a predetermined offset in the area of the side surface of the first head stick 211. The second detection line 222 may be provided internally at a predetermined offset in the area of the side surface of the second head stick 212 and may be provided spaced a predetermined margin distance DM apart from the ground. When the alignment structure 10 is installed outdoors, this is to prevent an end of the second detection line 222 from being covered by the length of grass, or to form the detection region close to a right triangle shape by having the end of the second detection line 222 and an end of the first detection line 221 connected horizontally to each other.

The launch monitor may identify a virtual line SL by connecting the ends of the detection lines 220 to each other. The launch monitor may determine a detection region by identifying the virtual line SL as a base, the second detection line 222 as a height, and the first detection line 221 as a hypotenuse. The launch monitor may store the detection lines 220 and detection regions formed when the alignment structure 10 is observed from the side without being tilted, and may calculate an offset angle between the launch monitor and a hitting direction by receiving changes in length or inclination of the detection lines 220 observed in the field and changes in the detection region.

The rotation center body 310 may be included at the end of the first head stick 211. In other words, a first end of the first head stick 211 may include the first connecting body 110, and a second end thereof may include the rotation center body 310.

The rotation center body 310 may be provided so that the side stick 410 is configured to be folded and unfolded. Accordingly, the rotation center body 310 may be connected to the first side stick 411, the second side stick 412, and the first head stick 211.

The first side stick 411 and the second side stick 412 may be configured to be folded and unfolded by the rotation center body 310 at a second angle. The rotation center body 310 may include a torsion spring and a stopper member, the first side stick 411 and the second side stick 412 may be unfolded by the elastic force of the torsion spring, and an angle between the first side stick 411 and the second side stick 412 may be maintained by the stopper member at the second angle. The first side stick 411 and the second side stick 412 may function as a three-point stand on the ground along with the second head stick 212.

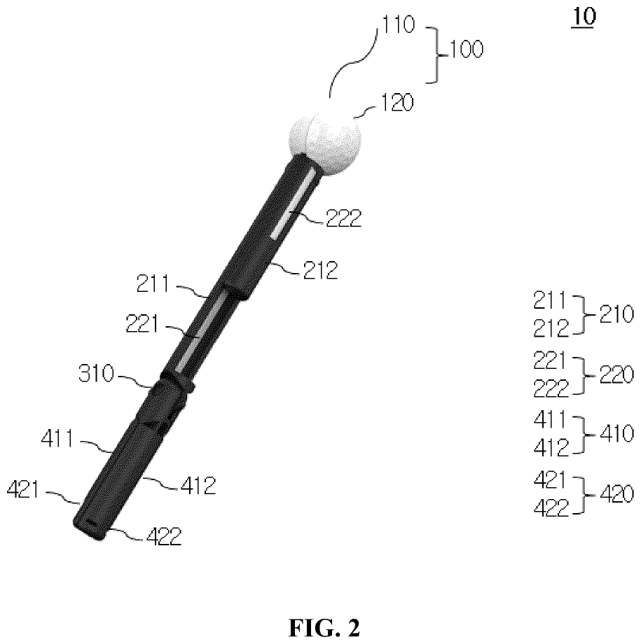

FIG. 2 is a view for describing the alignment structure in a folded state according to the exemplary embodiment of the present disclosure.

The alignment structure 10 of FIG. 2 is in the folded state, and the alignment stick 10 of FIG. 1 is prepared to be photographed with the launch monitor. That is, the alignment structures 10 of FIGS. 1 and 2 are physically identical to each other, and FIGS. 1 and 2 are intended to describe the changed state in which the second head stick 212 and the side sticks 410 are folded.

Referring to FIG. 2, the second connecting body 120 and the second head stick 212 may be folded at the first angle, and the first side stick 411 and the second side stick 412 may be folded at the second angle so that the alignment structure 10 can be changed into a straight line shape. As a result, a volume of the alignment structure 10 may be reduced, thereby making it easier to carry.

FIG. 3 is a side view for describing the alignment structure according to the exemplary embodiment of the present disclosure.

In the ready state, the alignment structure 10 may be supported from the ground based on the second head stick 212 extending from the connecting body 100. In outdoor situations, the detection lines 220 may not be captured due to obstacles such as grass or rocks. Accordingly, the first detection line 221 and the second detection line 222 may be located inside the first head stick 211 and the second head stick 212 by a predetermined offset distance OS, respectively.

Additionally, in the case of the second detection line 222, since interference by obstacles may be significant, the second detection line 222 may be included spaced the margin distance DM apart from the ground.

For example, the margin distance DM may be set so that the virtual line SL where the end of the first detection line 221 and the end of the second detection line 222 are parallel to the ground is created. This is only an example, and the virtual line SL may not be parallel to the ground.

The launch monitor may store visual information such as the length, angle, area, and direction of the virtual line SL, the first detection line 221, and the second detection line 222 when viewed from the side surface as shown in FIG. 3, and determine the direction of the ball (or a target direction in which the connecting body is facing) by comparing the stored visual information with the visual information of the virtual line SL, the first detection line 221, and the second detection line 222 sensed in the field.

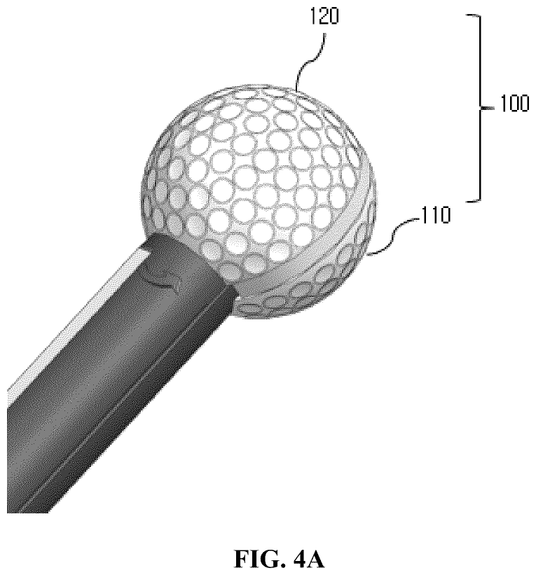

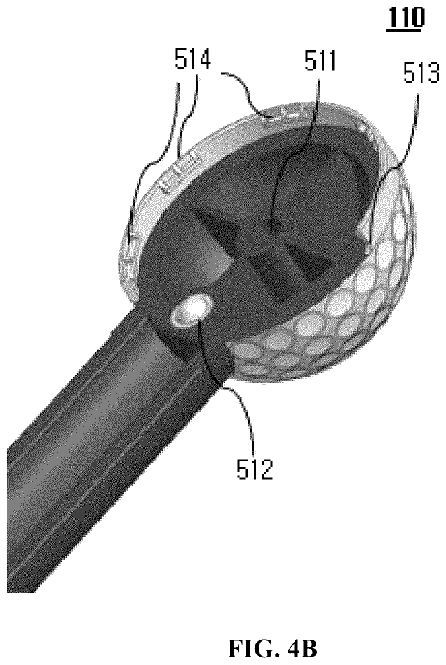

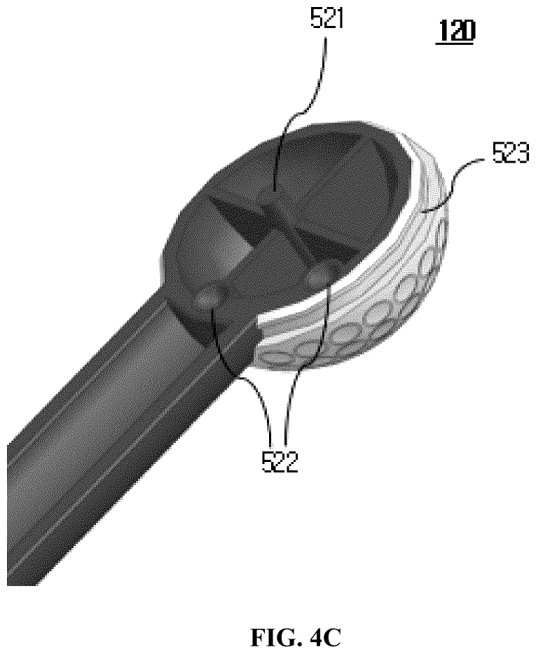

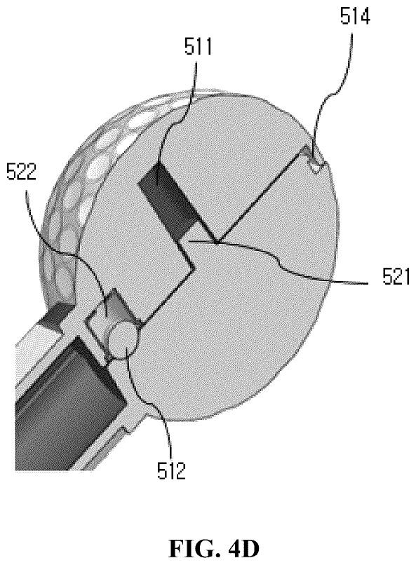

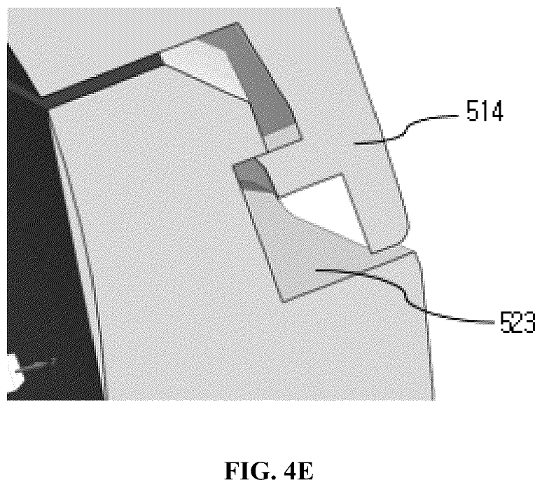

FIGS. 4A to 4E are views for describing the connecting body according to the exemplary embodiment of the present disclosure.

Referring to FIG. 4A, the first connecting body 110 and the second connecting body 120 may be combined with each other to form the connecting body 100.

FIGS. 4B and 4C are exploded perspective views of the first connecting body 110 and the second connecting body 120, respectively.

Referring to FIG. 4B, the first connecting body 110 may include a rotation shaft hole 511, a ball plunger 512, a stopper 513, and a snap fit 514, and referring to FIG. 4C, the second connecting body 120 may include a rotation shaft 521, ball plunger holes 522, and a sliding guide 523.

Referring to FIGS. 4B and 4C, the rotation shaft hole 511 and the rotation shaft 521 may coupled to each other so that the second connecting body 120 may rotate from the first connecting body 110 at the first angle. The rotation shaft 521 may be inserted into an inner region of the rotation shaft hole 511.

The ball plunger 512 and the ball plunger holes 522 may be provided to maintain the first rotated angle. Referring to FIGS. 4B and 4C, one ball plunger 512 and two ball plunger holes 522 located in the 6 o'clock and 4 o'clock directions may be provided, and in the folded state, the ball plunger 512 may be seated in the ball plunger hole 522 in the 6 o'clock direction, and in the ready state (unfolded state), the ball plunger 512 may be seated in the ball plunger hole 522 in the 4 o'clock direction. This is only an example and there may be at least two ball plunger holes 522 at various angles.

The stopper 513 may be provided to prevent the second connecting body 120 rotated to the first angle from rotating any further to a larger angle.

The snap fit 514 and the sliding guide 523 may be structurally coupled to each other, the snap fit 514 may prevent the first connecting body 110 and the second connecting body 120 from being easily disassembled, and the sliding guide 523 may be a means provided to enable the second connecting body 120 to rotate.

FIG. 4D is a cross-sectional view for describing components included in the connecting body 100.

Referring to FIG. 4D, a structure in which the rotation shaft 521 is coupled to the rotation shaft hole 511 and the ball plunger 512 is seated in the ball plunger hole 522 can be confirmed, and the first connecting body 110 may be structurally coupled to the second connecting body 120 by the snap fit 514.

FIG. 4E is a cross-sectional view for describing a coupling structure of the snap fit 514 and the sliding guide 523.

Referring to FIG. 4E, a protruding portion of the snap fit 514 may come into contact with a protruding portion of the sliding guide 523 so that the first connecting body 110 and the second connecting body 120 are coupled, and the second connecting body 120 may rotate at the first angle in a direction in which the sliding guide 523 extends.

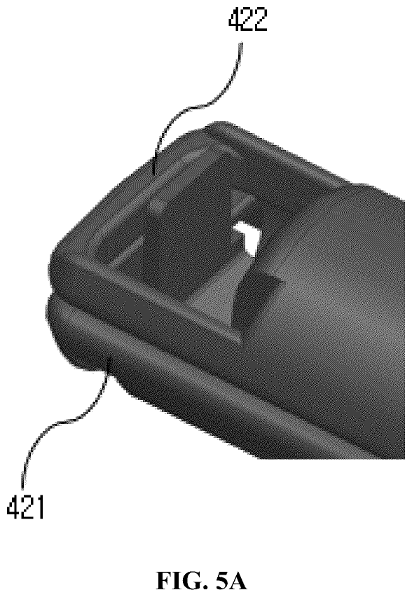

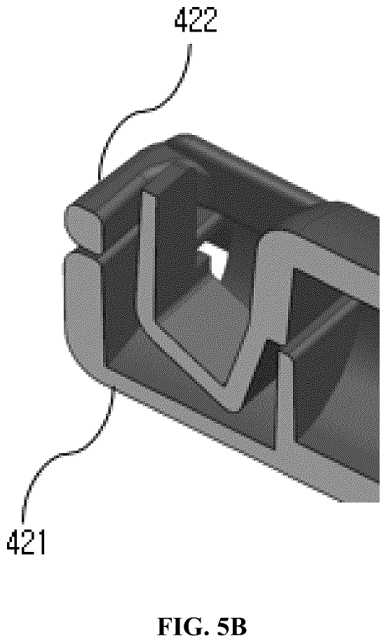

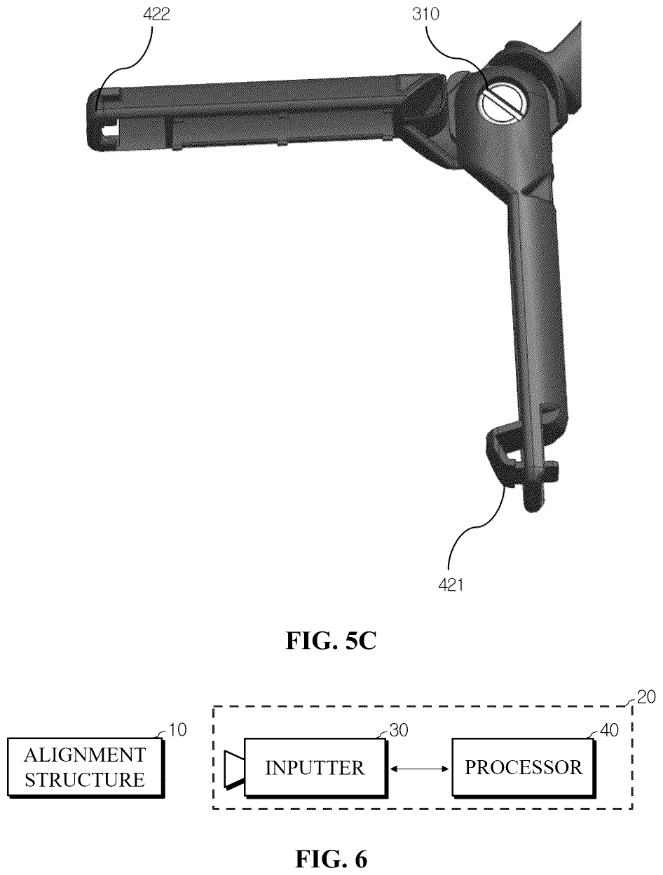

FIGS. 5A to 5C are views for describing a binding structure according to the exemplary embodiment of the present disclosure.

Referring to FIGS. 5A to 5C, the first binding structure 421 may be formed in a form in which a U-shaped sub-structure and a straight-line sub-structure are combined, and the second binding structure 422 may be implemented in a quadrangular hole form in which the U-shaped sub-structure can be seated. The U-shaped sub-structure of the first binding structure 421 may be folded by being combined with an end of the second binding structure 422, and the binding state may be released by pressing the U-shaped end.

Referring to FIG. 5C, the alignment structure 10 may include the first binding structure 421 and the second binding structure 422 provided to maintain a folded state, and may further include the rotation center body 310 provided to maintain an unfolded state.

The rotation center body 310 may include the torsion spring and the stopper member so that the side sticks 410 are unfolded such that the angle between the first side stick 411 and the second side stick 412 becomes the second angle, and oppositely, the first binding structure 421 and the second binding structure 422 may be maintained in a folded state.

A torsion spring shaft along which the torsion spring can be guided to be inserted may be formed in the rotation center body 310, and the torsion spring shaft may be formed in the first side stick 411 or may be formed in the second side stick 412. For example, when the torsion spring shaft is formed in the first side stick 411 or the second side stick 412, a guide hole for guiding the torsion spring shaft may be formed in each of the second side stick 412 or the first side stick 411. In addition, a screw hole may be formed in the torsion spring shaft, and the guide hole may be formed to correspond to a diameter of the torsion spring shaft and a diameter of a screw head, and, the first side stick 411 and the second side stick 412 may ultimately be fixed to be capable of performing folding and unfolding by inserting a screw into the screw hole and fixing the guide hole by the screw head.

Meanwhile, the side sticks 410 may further include various fastening structures that can be folded and fastened or unfolded.

FIG. 6 is a view for describing an electronic system including the alignment structure.

The electronic system may include the alignment structure 10 and an electronic device 20.

The electronic device 20 may include an inputter 30 and a processor 40, and the electronic device 20 may sense the appearance of the alignment structure 10. For example, the inputter 30 may be implemented as a camera to photograph the alignment structure 10, and the processor 40 may identify the appearance of the alignment structure 10 including the detection line 220 and calculate a direction in which the alignment structure 10 is facing.

The alignment structure 10 and the electronic device 20 may form the electronic system in that the electronic device 20 can identify the alignment structure 10 and calculate the correct hitting direction. Specifically, the electronic system may perform an alignment operation based on the result of identifying the detection line 220 included in the head stick 210.

The electronic device 20 may be, for example, a launch monitor and may be used in golf sports. However, the electronic device 20 is not limited thereto and may be implemented as various electronic devices such as a PC, a tablet, a PMP, a PDA, and a smartphone.

The inputter 30 may be implemented as various sensor devices capable of identifying an object, such as an image sensor, a lidar sensor, a radar sensor, or an ultrasonic sensor.

The processor 40 may be a configuration for controlling the electronic device 20 as a whole. For example, the processor 40 may be implemented as a digital signal processor (DSP), a microprocessor, or a time controller (TCON) that processes digital signals. However, the processor 40 is not limited thereto, and may include one or more of a central processor (CPU), a micro controller unit (MCU), a micro processor (MPU), a controller, an application processor (AP), a communication processor (CP), and an ARM processor or may be defined by these terms. In addition, the processor 40 may be implemented as a system on chip (SoC) and large scale integration (LSI) with a built-in processing algorithm, or may be implemented in the form of a field programmable gate array (FPGA).

Meanwhile, although not shown, of course, the electronic device 20 may further include a communication unit including a communication module for communicating with an external electronic device, a memory device capable of temporarily or non-temporarily storing data, a display device capable of outputting data in the form of an image, and a speaker device capable of outputting data in the form of sound.

In this case, the method to be performed by the electronic device may be stored in the form of instructions in a memory device, which is a non-transitory computer readable recording medium.

An alignment structure according to the technical idea of the present disclosure can accurately detect the direction in which the alignment structure is directed by recognizing a plurality of detection lines and a three-dimensional detection region.

Additionally, the alignment structure can be folded for easy portability in response to outdoor launch monitors, and includes a foldable head stick and side stick for stable mounting.

Although the embodiments have been described as above with limited drawings, those skilled in the art can apply various technical modifications and variations based on the embodiments. For example, suitable results may be achieved even when the described techniques are performed in an order that is different from that of the described method, and/or components of the described systems, structures, devices, circuits, or the like are coupled or combined in a manner that is different from that the described method, or are replaced or substituted by other components or equivalents.

Therefore, other implementations, other embodiments, and equivalents to the claims are also included in the scope of the claims described below.

What is claimed is:

1. An alignment structure comprising:
a connecting body;
a head stick including a first head stick extending from the connecting body and a second head stick that is provided to be able to be supported from the ground by extending in a direction of the ground while being separated from the first head stick at a first angle; and
a side stick configured to enable three-point support from the ground along with the second head stick.

2. The alignment structure of claim 1, wherein the head stick includes a detection line provided on a side surface of the head stick.

3. The alignment structure of claim 2, wherein the detection line includes a first detection line provided on an inner side surface of the first head stick and a second detection line provided on an outer side surface of the second head stick.

4. The alignment structure of claim 3, wherein the detection line includes an adhesive sheet that emits or reflects light so that a camera is able to easily identify the detection line.

5. The alignment structure of claim 3, wherein the second detection line is provided on the second head stick to be spaced a predetermined margin distance apart from the ground.

6. The alignment structure of claim 1, wherein the connecting body includes a first connecting body and a second connecting body structurally connected to the first connecting body and capable of rotating at a first angle, and
the first head stick extends from the first connecting body, and the second head stick extends from the second connecting body.

7. The alignment structure of claim 6, wherein the first connecting body includes a ball plunger, and
the second connecting body includes a plurality of ball plunger holes in which the ball plunger is able to be seated.

8. The alignment structure of claim 6, wherein the first connecting body includes a snap fit, and
the second connecting body includes a sliding guide that is in contact with the snap fit to enable rotational motion.

9. The alignment structure of claim 1, wherein the side stick is provided so that the side stick extends from the head stick and is configured to be folded and unfolded, and is able to be supported from the ground along with the second head stick.

10. The alignment structure of claim 9, wherein the side stick includes a first side stick and a second side stick, each of which includes a binding structure at one end to maintain a folded state.

11. An alignment structure comprising:
a connecting body including a first connecting body and a second connecting body structurally connected to the first connecting body and capable of rotating at a first angle;
a head stick including a first head stick extending from the first connecting body and a second head stick extending from the second connecting body and provided to be separated from the first head stick at the first angle; and
a side stick configured to enable three-point support from the ground along with the second head stick.

12. The alignment structure of claim 11, wherein the head stick includes a detection line provided on a side surface of the head stick.

13. The alignment structure of claim 12, wherein the detection line includes a first detection line provided on an inner side surface of the first head stick and a second detection line provided on an outer side surface of the second head stick.

14. The alignment structure of claim 13, wherein the detection line includes an adhesive sheet that emits or reflects light so that a camera is able to easily identify the detection line.

15. The alignment structure of claim 13, wherein the second detection line is provided on the second head stick to be spaced a predetermined margin distance apart from the ground.

16. The alignment structure of claim 11, wherein the first connecting body includes a ball plunger, and
the second connecting body includes a plurality of ball plunger holes in which the ball plunger is able to be seated.

17. The alignment structure of claim 16, wherein the first connecting body includes a snap fit, and
the second connecting body includes a sliding guide that is in contact with the snap fit to enable rotational motion.

18. The alignment structure of claim 11, wherein the side stick is provided so that the side stick extends from the head stick and is configured to be folded and unfolded and is able to be supported from the ground along with the second head stick.

19. The alignment structure of claim 18, wherein the side stick includes a first side stick and a second side stick, each of which includes a binding structure at one end to maintain a folded state.

20. An electronic system comprising:
an alignment structure that includes:
a connecting body;
a head stick including a first head stick extending from the connecting body and a second head stick extending in a direction of the ground and provided to be supported from the ground while being separated from the first head stick at a first angle; and
a side stick configured to enable three-point support from the ground along with the second head stick; and
an electronic device that photographs the alignment structure and performs alignment operations based on the results of identifying a detection line included in the head stick.

21. The electronic system of claim 20, wherein the electronic device determines a hitting direction based on a virtual line connecting an end of a first detection line provided on an inner side surface of the first head stick and an end of a second detection line provided on an outer side surface of the second head stick.
